(19) United States
(12) Patent Application Publication
(10) Pub. No.: US 2017/0362093 A1
(43) Pub. Date: Dec. 21, 2017

(54) METHOD AND DEVICE FOR CONTROLLING A WATER CONDITIONING SYSTEM

(71) Applicant: Emonix, Inc., Madison, WI (US)

(72) Inventors: Neil A. Klingensmith, Madison, WI (US); Zachary CJ LaVallee, Wildwood, MO (US); Suman Banerjee, Madison, WI (US)

(73) Assignee: Emonix, Inc., Madison, WI (US)

(21) Appl. No.: 15/186,112

(22) Filed: Jun. 17, 2016

(51) Int. Cl. C02F 1/00; C02F 1/42; C02F 1/44; C02F 101/10

(52) U.S. Cl. CPC C02F 1/008; C02F 1/441; C02F 1/42; C02F 2209/055; C02F 2101/10; C02F 2209/40; C02F 2303/16; C02F 2209/02

(57) ABSTRACT

A method includes receiving an ion concentration measurement from a sensor electrode measuring a fluid stream exiting a water conditioning system. A hardness metric is generated based on the ion concentration measurement. A regeneration signal is communicated to the water conditioning system based on the hardness metric. A system includes a sensor electrode to generate an ion concentration measurement in a fluid stream exiting a water conditioning system and a controller to generate a hardness metric based on the ion concentration measurement and communicate a regeneration signal to the water conditioning system based on the hardness metric.

### BACKGROUND

### Field of the Disclosure

The present disclosure relates generally to controlling the charging of a water conditioning system using water hardness measurements.

### Description of the Related Art

Regional water politics are increasingly putting pressure on local governments to reduce their fresh water consumption and water pollution. For this reason, the availability of fresh water will set limits on population expansion in urban centers as well as the productivity of arable land, both in the United States and abroad.

In many metropolitan areas, water softeners are a primary source of sodium and chloride ion pollution. Pollution of fresh water sources is a major concern, because it threatens the supply of potable water on which urban populations depend. Salt waste produced by softeners is discharged into waste water treatment facilities. Once dissolved, it is difficult and expensive to remove.

Water softeners stop lime buildup in pipes and equipment by removing dissolved minerals, such as calcium and magnesium ions, from the water supply. This removal is typically accomplished by exchanging calcium and magnesium ions with sodium ions using a filtration medium. As calcium and magnesium-rich water passes through a filtration medium, sodium ions, weakly bound to the medium, are released into solution. The calcium and magnesium ions replace the sodium on the filtration medium. Eventually, the surface of the filtration medium becomes saturated with calcium and magnesium ions, and it can no longer treat water. The medium is regenerated by flushing with concentrated salt brine, which replaces calcium and magnesium ions with sodium, preparing the softener to treat more water.

However, large amounts of water pollution are not necessary to provide soft tap water in buildings. It has been observed that many softeners are configured incorrectly, leading to excessive backwashing and wasteful salt consumption. Furthermore, there is a lack of information about water softener salt consumption that leads to malfunctioning systems.

Most water treatment systems use open-loop control, meaning that there is no sensor on the outgoing treated water to inform decisions about when to regenerate the filtration medium. Instead, the control systems usually use simple time-based (e.g., regenerate once a week on Tuesday) or flow-based (e.g., regenerate every 1000 gallons) schedules.

Inconsistencies in the incoming water quality, degradation of the filtration medium, or variation of the water usage pattern of the building can make the system unstable. In many municipal water systems, multiple wells are employed to supply water, each having different hardness characteristics. Water softeners tend to be set to use more salt than strictly required for several reasons. Adding too much salt doesn't negatively impact the piping of the building and won't be noticed by the user. The cost of maintenance, especially in large buildings, for cleaning up lime is higher than the cost of additional bags of salt. This is primarily due to the cost of the labor involved. However, gross overusage of salt, is also expensive in the long run.

Because water softener systems are typically located in remote service areas, problems can go undetected for months or years. Furthermore, existing softener controllers do not typically provide sufficient information for maintenance staff to detect misconfigurations.

Misprogrammed controllers can cause inefficiencies in the softener system by allowing either too much or too little water to flow through the resin bed before it is depleted. Regenerating the resin bed too early can result in excessive salt use and increased sodium chloride pollution. Regenerating too late can cause the resin bed to become totally depleted, resulting in hard water being distributed to the building. The hard water can cause pipes to clog and eventually destroy equipment. Unfortunately, many existing softener controllers are difficult to program. Even experienced maintenance personnel can make mistakes in programming the softener controllers, resulting in over-softened or under-softened water. Reprogramming softeners is routinely required after a power failure or after a changeover from daylight savings time.

Low flow rates through a softener tank can result in nonuniform flow of water through the filtration medium, causing some regions to deplete more quickly than others. Under low-flow conditions, water tends to move through a column in the center of the softener tank, quickly depleting the medium in that region. For this reason, it may be necessary to regenerate the water softener more frequently during periods of low consumption.

Variability of incoming water quality creates obstacles when provisioning a treatment system because it is difficult to predict the amount of water a system can treat before it needs to be regenerated. Since the hardness of incoming water commonly varies by 10% or more over the course of days or weeks, softeners are often configured to deal with the worst case hardness. Even when incoming water has relatively low hardness, the softener system will still be regenerated on the same schedule as under maximum hardness conditions, because stock water softeners do not have any way of sensing water quality.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 is a simplified block diagram of a water conditioning system in accordance with some embodiments.

FIG. 2 is a flow diagram illustrating a method for controlling a water conditioning system in accordance with some embodiments.

### DETAILED DESCRIPTION

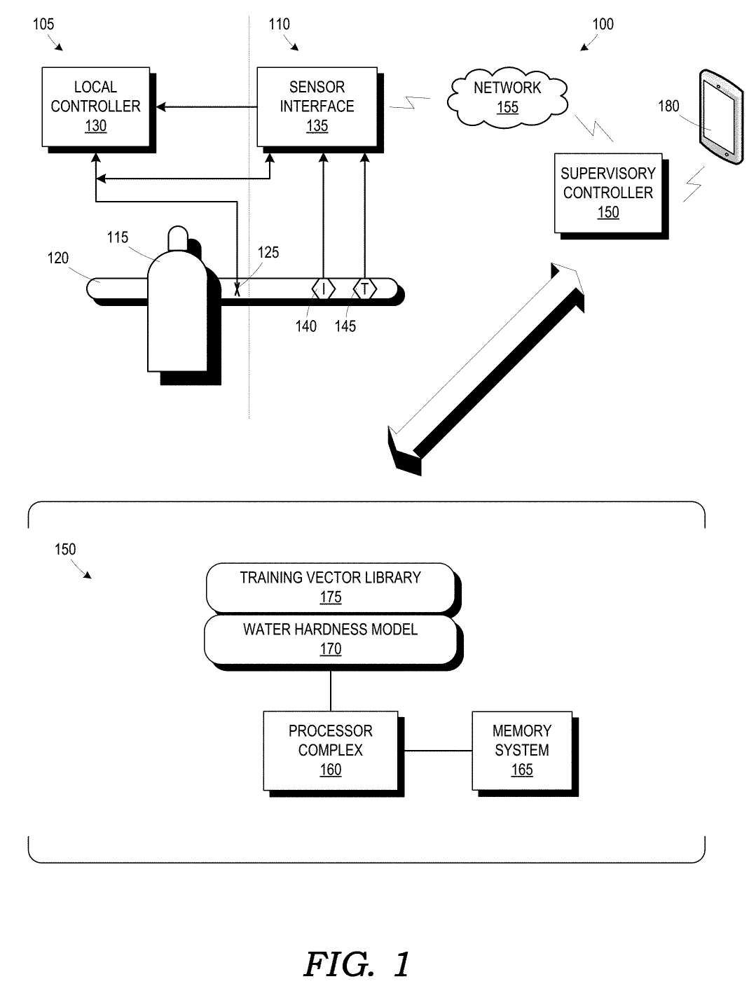

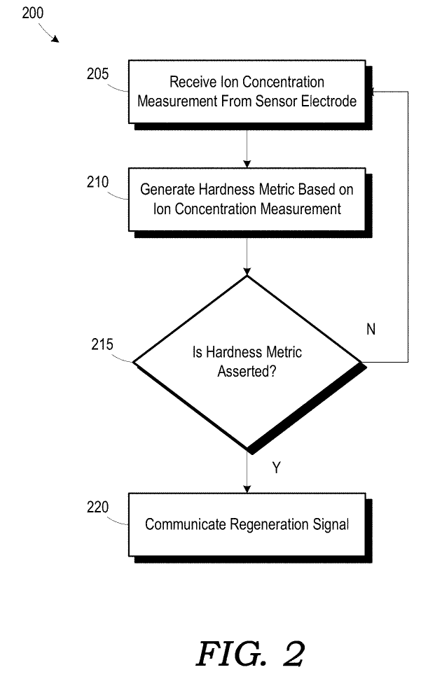

FIGS. 1-2 illustrate example techniques for controlling a water conditioning system, such as a water softener. In the illustrated example, an ion detection sensor is employed to measure an ion concentration in a fluid stream exiting a conditioning system. The ion concentration is provided as an input to a conditioning model to determine the need to regenerate the conditioning system. Other sensor inputs, such as temperature and flow, as well as computed inputs generated based on the raw measurement data, may be provided as inputs to the conditioning model.

FIG. 1 is a simplified block diagram of a system 100 for controlling conditioning of a fluid stream. The system 100 includes a water conditioner 105 (e.g., a water softener, reverse osmosis unit, de-ionizer, etc.) and a hardness detection system 110 for determining a need to regenerate the water conditioner 105. The water conditioner 105 includes a conditioning medium 115 (e.g., resin bed, membrane, etc.) coupled to water supply piping 120, a flow sensor 125, and a local controller 130. The water conditioner 105 may represent a conventional system that measures the flow of water through the conditioning medium 115 and regenerates based on a usage parameter (i.e., actual measurement or usage history). The flow sensor 125 generates a train of pulses based on the volume of water flowing through the water supply piping 120.

The hardness detection system 110 interfaces with the water conditioner 105 to generate a hardness metric for the treated water stream exiting the water conditioner 105. In some embodiments, the hardness detection system 110 includes a sensor interface 135, an ion concentration sensor 140, a temperature sensor 145, and a supervisory controller 150 that communicates with the sensor interface 135 over a communication network 155 (e.g., the internet). In some embodiments, the ion concentration sensor 140 is a calcium ion selective electrode that outputs a voltage signal related to the calcium concentration of the water stream. Although hard water typically includes multiple ions, such as calcium and magnesium, measuring only one ion is generally sufficient for detecting the hardness of the water. In some embodiments, multiple ion concentration sensors 140 may be employed to measure different constituents. The sensor interface 135 may interface with the flow sensor 125 directly or indirectly through the local controller 130. The sensor interface 135 may include an accumulator (not separately shown) for counting the pulses generated by the flow sensor 125. In some embodiments, the sensor interface 135 includes a Wi-Fi interface for initiating a wireless connection to the communication network 155. In general, the sensor interface 135 collects data from the flow sensor 125, ion concentration sensor 140, and the temperature sensor 145 over a sampling interval and sends time series data to the supervisory controller 150. One example implementation of the sensor interface 135 is a custom device including a microcontroller with a Wi-Fi network controller (e.g., xBee) that allows it to directly connect to a local network. The sensor interface 135 may include programmable digital/analog sensor inputs through which the sensors 125, 140, 145 can be connected to collect data. On-board memory may be provided to allow the sensor interface 135 to cache data samples in the event of a network outage. The sensor interface 135 samples the sensors 125, 140, 145, preprocesses and caches the data, and relays the data to the supervisory controller 150 through the communication network 155. When the supervisory controller 150 determines that a regeneration is required, it sends a message to the sensor interface 135, which, in turn, initiates a regeneration on the water conditioner 105 by interfacing with the local controller 130.

In the illustrated embodiment, the supervisory controller 150 is illustrated as being remote from the sensor interface 135, i.e., a distributed computing environment, and as being a separate entity. However, in some implementations, the supervisory controller 150 may be located at the site of the water conditioner 105 and directly connected to the sensor interface 135 or the supervisory controller 150 and the sensor interface 135 may be integrated into single entity. The supervisory controller 150 may be implemented in virtually any type of electronic computing device, such as a desktop computer, a server, a minicomputer, a mainframe computer, a supercomputer, an application specific integrated circuit device, etc. The present subject matter is not limited by the particular implementation of the computing system used for implementing the supervisory controller 150.

In some embodiments, the supervisory controller 150 includes a processor complex 160 communicating with a memory system 165. The memory system 165 may include nonvolatile memory (e.g., hard disk, flash memory, etc.), volatile memory (e.g., DRAM, SRAM, etc.), or a combination thereof. The processor complex 160 may be any suitable processor known in the art, and may represent multiple interconnected processors in one or more housings or distributed across multiple networked locations. The processor complex 160 executes software instructions stored in the memory system 165 and stores results of the instructions in the memory system 165 to implement a water hardness model 170. In general, the water hardness model 170 is trained using a training vector library 175 and determines a hardness metric for an incoming sample of data communicated by the sensor interface 135, as described in greater detail below.

In some embodiments, the water hardness model 170 is a multivariate model that receives multiple input values and generates a binary water hardness metric indicating whether the conditioning medium 115 is likely to be depleted and in need of regeneration. The specific implementation of the water hardness model 170 may vary depending on the modeling technique selected. In some embodiments, the water hardness model 170 implements an adaptive control algorithm using a support vector machine (SVM) model. In general, a SVM technique is supervised learning model with associated algorithms that analyze data for classification analysis. Given a set of training examples with known binary classifications (e.g., soft water or hard water), an SVM training algorithm builds a model that assigns new samples into one of the binary classification categories, making it a non-probabilistic binary linear classifier. For example, water samples associated with training vectors in the library 175 may be manually tested using a chemical hardness test kit that provides a reliable measurement of water hardness, but requires a time-consuming manual process that is not practical to automate. The SVM model uses the training vector library 175, each training vector having a known classification, and generates a linear function separating feature vectors in the two classes—hard water sample vectors lie on one side of the function, and soft water vectors lie on the other. Unknown incoming feature vectors are classified based on which side of the linear function they fall. Of course, the water hardness model 170 may employ different modeling techniques. In some embodiments, the water hardness model 170 may be a relatively simple equation based thresholding model (e.g., linear, exponential, weighted average, etc.) or a more complex model, such as a neural network model, a principal component analysis (PCA) model, or a projection to latent structures (PLS) model. For purposes of the following illustration, the water hardness model 170 is described using a SVM approach.

The sensor interface 135 gathers data from the sensors 125, 140, 145 over a sampling interval (e.g., 5 minutes, 15, minutes, 30 minutes, one hour, etc.) and communicates the data to the supervisory controller 150 in real time. The supervisory controller 150 clusters each set of sensor readings into a feature vector and provides it to the water hardness model 170 to generate the binary water hardness metric indicative of whether the conditioning medium 115 needs to be regenerated.

In general, the ion concentration sensor 140 produces noisy data. In particular, the output of the ion concentration sensor 140 may drift over time, and variability in flow rate through the water conditioner 105 may result in errant spikes in the output of the ion concentration sensor 140, even though the water conditioner 105 is not actually producing hard water. During depletion of the conditioning medium 115, the output of the ion concentration sensor 140 increases synchronously with the calcium ion concentration. Using an SVM technique, readings from multiple sensors may be integrated to detect a hard water condition.

In some embodiments, the feature vector for an incoming sample may include:

$$\begin{matrix}Calcium Ion Concentration ( CAC ) : & [ {Ca}_{2}^{+} ] = {g}^{k ( V - a )} , \\ Flow Rate : & f ( gallons \text{/} minute ) , \\ Temperature : & T ( °C . ) , \\ Derivative of CAC : & d ( [ {Ca}_{2}^{+} ] / dt , and \\ Normalized CAC : & C \hat{A} C = [ {Ca}_{2}^{+} ] ( 1 - {e}^{- ( \frac{kf}{T} )} ) .\end{matrix}$$

Note that the feature vector includes both raw measurement data and processed measurement data. Although the calcium ion concentration is shown as a computed value based on the voltage output by the ion concentration sensor 140, the raw voltage signal may be employed as the calcium ion concentration measurement. In some embodiments, not all of the inputs may be employed, and in other embodiments, additional inputs may be added to or substituted for those listed. In general, the processed measurement data is useful for rejecting noise and drift of the raw calcium ion concentration represented by the measured electrode voltage, v. The voltage output of the ion concentration sensor 140 is a function of the water's calcium ion concentration, and it should generally be low for soft water and high for hard water.

To detect hard water before the calcium ion concentration (sensor voltage) gets too high, additional features are added to distinguish between false spikes and hard water. False spikes generally occur because of low flow rate through the water conditioner 105. In addition, increased water temperature has a tendency to cause erroneous high readings from the ion concentration sensor 140.

It was determined that the shape of the CAC curve as it increases is different in a false spike as compared to a true hardness event. This shape difference may be employed to detect water hardness events early, because the shape of the curve can be identified before its maximum amplitude is reached. The derivative of the CAC is indicative of the shape of the curve. In general, hard water events have a derivative that is smaller in magnitude than false spike events. An apparent reason for this difference is that at the end of a filtration cycle, when the conditioning medium 115 is almost depleted, the conditioning medium 115 exhibits an intermediate phase in which it slowly becomes less efficient at removing calcium ions. That intermediate phase generally lasts for several hours. Erroneous spikes, on the other hand, are caused by changes in water usage patterns which generally happen over much shorter time intervals. Providing multiple sensor inputs, as well as the shape of the ISE output, to the water hardness model 170 improves the efficacy of the water hardness model 170 for distinguishing between truly hard water events and false sensor spikes.

The hardness detection system 110 provides real time control of the water conditioner 105.

Upon identifying a hard water condition, the supervisory controller 150 sends a regeneration signal to the sensor interface 135. The sensor interface 135 interfaces with the local controller 130 of the water conditioner 105 to facilitate a regeneration. In some embodiments, the supervisory controller 150 may also send a regeneration notification message to a remote device 180, such as a mobile telephony device to communicate the regeneration event to an operator of the system 100 including the water conditioner 105.

In some embodiments, the local controller 130 may have a signal terminal configured to receive an external regeneration signal. In other embodiments, the sensor interface 135 may simulate flow measurements on a flow sensor input terminal to cause the regeneration threshold of the local controller 130 to be artificially met. For example, it is common in conventional water conditioners 105 that a regeneration is implemented after a predetermined volume of water has been treated. Pulses from the flow sensor 125 are counted and a regeneration is triggered when the pulse count exceeds a threshold. In addition to monitoring the output of the flow sensor 125 to measure flow rate, the sensor interface 135 may also inject a pulse train on the output of the flow sensor 125 which is accumulated by the local controller 130, thereby triggering a regeneration. In general, the number of pulses in the injected pulse train is sufficient to saturate the pulse counter or exceed its threshold in the local controller 130.

FIG. 2 is a flow diagram illustrating a method 200 for controlling a water conditioning system in accordance with some embodiments. In method block 205 an ion concentration measurement is received from a sensor electrode, such as the ion concentration sensor 140. In method block 210, a hardness metric (e.g., a binary metric that is asserted when the water is classified as being “hard” and deasserted when the water is classified as being “soft”) is generated based on the ion concentration metric. In method block 215, it is determined if the hardness metric is asserted, If the hardness metric is asserted, a regeneration signal is communicated to the water conditioner 105 in method block 220. If the hardness metric is not asserted in method block 215, the method returns for the next measurement in method block 205.

A method includes receiving an ion concentration measurement from a sensor electrode measuring a fluid stream exiting a water conditioning system. A hardness metric is generated based on the ion concentration measurement. A regeneration signal is communicated to the water conditioning system based on the hardness metric.

A system includes a sensor electrode to generate an ion concentration measurement in a fluid stream exiting a water conditioning system and a controller to generate a hardness metric based on the ion concentration measurement and communicate a regeneration signal to the water conditioning system based on the hardness metric.

In some embodiments, certain aspects of the techniques described herein may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as flash memory, a cache, random access memory (RAM), or other non-volatile memory devices, and the like. The executable instructions stored on the non-transitory computer readable storage medium may be in source code, assembly language code, object code, or other instruction format that is interpreted or otherwise executable by one or more processors.

A non-transitory computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
receiving an ion concentration measurement from a sensor electrode measuring a fluid stream exiting a water conditioning system;
generating a hardness metric based on the ion concentration measurement; and
communicating a regeneration signal to the water conditioning system based on the hardness metric.

2. The method of claim 1, further comprising:
generating a computed input value based on the ion concentration measurement; and
generating the hardness metric based on the ion concentration measurement and the computed input value.

3. The method of claim 2, wherein generating the computed input value comprises generating a derivative of the ion concentration measurement.

4. The method of claim 1, further comprising:
receiving a temperature measurement and a flow rate measurement of the fluid stream; and
generating the hardness metric based on the ion concentration measurement, the temperature measurement, and the flow rate measurement.

5. The method of claim 4, wherein the ion concentration measurement, the temperature measurement, and the flow rate measurement each comprises time series data collected over a sampling interval.

6. The method of claim 5, further comprising:
generating a computed input value based on the ion concentration measurement, the temperature measurement, and the flow rate measurement; and
generating the hardness metric based on the computed input value.

7. The method of claim 6, wherein generating the computed input value comprises normalizing the ion concentration measurement based on the temperature measurement and the flow rate measurement.

8. The method of claim 5, wherein generating the hardness metric comprises providing the ion concentration measurement, the temperature measurement, and the flow rate measurement as inputs to a multivariate model.

9. The method of claim 4, further comprising generating the hardness metric based on the ion concentration measurement, the temperature measurement, the flow rate measurement, a derivative of the ion concentration measurement, and a computed input value generated by normalizing the ion concentration measurement based on the temperature measurement and the flow rate measurement.

10. The method of claim 1, wherein communicating the regeneration signal comprises injecting a simulated pulse train on a flow sensor input terminal of the water conditioning system.

11. A system, comprising:
a sensor electrode to generate an ion concentration measurement in a fluid stream exiting a water conditioning system; and
a controller to generate a hardness metric based on the ion concentration measurement and communicate a regeneration signal to the water conditioning system based on the hardness metric.

12. The system of claim 11, wherein the controller is to generate a computed input value based on the ion concentration measurement and generate the hardness metric based on the ion concentration measurement and the computed input value.

13. The system of claim 12, wherein the computed input value comprises a derivative of the ion concentration measurement.

14. The system of claim 11, further comprising:
a temperature sensor to generate a temperature measurement of the fluid stream; and
a sensor interface to receive a flow rate measurement of the fluid stream from the water conditioning system and communicate the flow rate measurement and the temperature measurement to the controller, wherein the controller is to generate the hardness metric based on the ion concentration measurement, the temperature measurement, and the flow rate measurement.

15. The system of claim 14, wherein the ion concentration measurement, the temperature measurement, and the flow rate measurement each comprises time series data collected over a sampling interval.

16. The system of claim 15, wherein the controller is to generate a computed input value based on the ion concentration measurement, the temperature measurement, and the flow rate measurement and generate the hardness metric based on the computed input value.

17. The system of claim 16, wherein the computed input value comprises a normalized ion concentration measurement.

18. The system of claim 15, wherein the controller is to implement a multivariate model to generate the hardness metric based on the ion concentration measurement, the temperature measurement, and the flow rate measurement.

19. The system of claim 14, wherein the controller is to generate the hardness metric based on the ion concentration measurement, the temperature measurement, the flow rate measurement, a derivative of the ion concentration measurement, and a computed input value generated by normalizing the ion concentration measurement based on the temperature measurement and the flow rate measurement.

20. The system of claim 11, wherein the controller is to inject a simulated pulse train on a flow sensor input terminal of the water conditioning system.
